(19) United States
(12) Patent Application Publication
(10) Pub. No.: US 2003/0058942 A1
(43) Pub. Date: Mar. 27, 2003

(54) Method of running an algorithm and a scalable programmable processing device

(76) Inventors: Christian Hentschel, Eindhoven (NL); Shaomin Peng, Yorktown Heights, NY (US); Cornelis Conradus Adrianus Maria Van Zon, Peekskill, NY (US); Maria Gabrani, Eindhoven (NL); Elisabeth Francisca Maria Steffens, Eindhoven (NL); Reinder Jaap Bril, Eindhoven (NL)

Correspondence Address: U.S. Philips Corporation, 580 White Plains Road, Tarrytown, NY, 10591, US

(21) Appl. No.: 09/872,931

(22) Filed: Jun. 1, 2001

(51) Int. Cl. H04N 7/12

(52) U.S. Cl. 375/240.12; 375/240.25

(57) ABSTRACT

Nowadays, programmable components (1304), rather than dedicated single-function components can perform continuous media processing in consumer devices, like digital television sets (1310), set-top boxes, PCs, or VCRs. The media processing algorithms that are written for those programmable components (1304), must be designed to provide a plurality of output quality levels in exchange for required processing resources. Since resources are finite, the media processing algorithms must be controlled in their resource usage and the output quality level they provide. Users of consumer devices do not like to see major changes in the quality of, for example, a video they are watching. Therefore, typical algorithm characteristics like the functions an algorithm comprises, the resource usage per function and the quality level per function are used to provide smoother quality transitions.

The invention relates to a method of running an algorithm wherein the algorithm comprises a first function and a second function.

Furthermore the invention relates to scalable systems and more particularly to scalable multimedia communications systems such as an ATSC compliant video decoder.

An embodiment of the method and the system of the kind set forth above is known from Scalable Video Decoder and its Application to Multi-channel Multicast system (IEEE 19th International conference on consumer electronics, year 2000, Page 232 to 233. Here, a scalable algorithm is described to be used within real time systems that have limited resources and time critical algorithms. An example of a real time system with these characteristics is a video decoder to be used within a multi-channel multicast system and examples of limited resources are a physical memory, a main processor, and an input/output device. The scalable algorithm, for example a decoding algorithm for video, comprises a plurality of functions like, for example low pass filtering and upsampling. For each function the resource requirement in terms of CPU load is determined per number of video channels, for example 1, 4, or 8 channels, that can be decoded simultaneously. The functions that can be used within the algorithm are derived from the allowed CPU load and the budget each function is allowed to use must be allocated to each function individually.

Furthermore, it is generally known that the current approach for measuring complexity-distortion in a given system is to measure the operational curves for a particular data model (algorithm). Using a generic IDCT algorithm of an MPEG2 decoder as an example, the algorithm assumes that all the data inside each 8×8 block is in use. The total number of multipliers and adders is a fixed number. However, with one particular algorithm, if the data pattern changes, the number of computational steps can be changed, hence the complexity regarding the computation time of the algorithm is different, see FIG. 2. With the change of complexity levels, the output distortion is also different, i.e. different operational points 202 are utilized. The corresponding operational curve for this algorithm can be measured. If a different IDCT algorithm is adopted for the decoder, then a different operational curve can be drawn, e.g. curves 204, 206.

Rapid development in the multimedia processing industry has promoted programmable multimedia processing devices instead of traditional dedicated hardware solutions, e.g. Application Specific Integrated Circuits (ASICs). The programmable functionality of software-oriented devices has tremendously increased the flexibility of these types of multimedia and communication systems. Programmable devices are commonly used for adjusting or scaling functions complexity to certain levels according to available computational resources. This provides system scalability. However, when function complexity is scaled down, the performance of the system often degrades as compared to conventional dedicated hardware solutions. Therefore it is desirable to minimize performance degradation or distortion, at each function complexity level to maintain the overall performance of the system.

In theory, scalability deals with the tradeoff of function complexity and distortion via information rate and resource constraints. When computational resources decrease, the computing or processing power for performing the original amount of function complexity is decreased, thereby forcing the scalable algorithm to retreat to a lower level of function complexity.

One example of where a scalable design can be utilized is in a Digital Television (DTV) video decoder adapted to receive and decode information streams, e.g. television signals. The processing capability of the decoder is practically limited by the constraints of the decoder's processor, e.g. available computing resources. The decoder's processing capabilities may be limited to the point where it is insufficient for processing the received bitstream for displaying at an accepted quality standard. Hence, one way to enable the processor to decode the bitstream is to lower the quality of one of the functions. For example, the quality displayed in a Picture-In-Picture (PIP) window may be set lower (still acceptable) than the quality of the main channel being displayed by lowering the processing complexity of the windowed bitstream without altering the decoding quality of the main bitstream corresponding to the main channel. Accordingly, different processing complexities can be used for different bitstreams depending upon a respective modes of operations. This in turn permits the limited processing capabilities of the decoder to be better utilized to enable multiple bitstreams to be simultaneously processed.

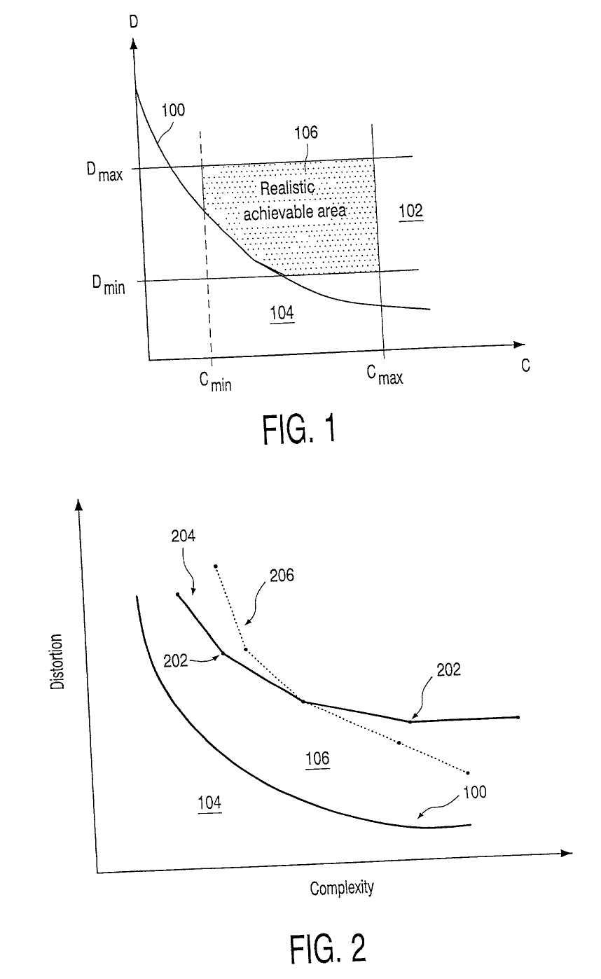

Referring now to FIG. 1, the Information-Based Complexity theory (IBC) shows that there is a minimal Complexity-Distortion (C-D) bound 100 for each given system. FIG. 1 shows that the rate distortion bound 100 is a convex function. This curve 100 precisely defines the theoretical boundary between achievable function complexity-distortion (region 102) and non-achievable function-complexity distortion (region 104). For purposes of background, C. E. Shannon published his work on Information Theory (IT) in 1948. As a branch of IT, Rate Distortion Theory (RDT) comes under the umbrella of source coding and compression, which is concerned with the tasks of maximally stripping redundancy from a source, subject to a quality criterion. In other words, RDT is concerned with representing a source with the fewest number of bits possible for a given reproduction quality. The tradeoff encountered in RDT is between information rate and output distortion. It should be recognized though that in RDT, there are typically no computational constraints on what the output decoding system can do.

To extend RDT to get complexity-distortion tradeoff and scalability issues investigated, the Information-Based-Complexity (IBC) theory was developed. IBC is a branch of computational complexity that studies problems for which the information is partial, contaminated, and priced. IBC claims that the computation of an algorithm could be scaled down by limiting the amount of input information to be processed. The complexity of an algorithm can be generalized to a function of the amount of information processed to generate an output sequence.

As indicated, the region 102 above the curve 100 is theoretically algorithm achievable, while the region 104 underneath is non-achievable. For a particular system, the complexity is limited. In other words, the complexity of the system has a boundary in order to let the system perform normally. The boundary of the complexity is described as [Cₘᵢₙ, Cₘₐₓ]. Furthermore, the output quality also has limitations, i.e. the distortion range [Dₘᵢₙ, Dₘₐₓ]. Dₘᵢₙ means the best result the system can provide, while Dₘₐₓ means the worst result that the user could tolerate. Hence, the workable region of a realistic system is the region 106.

Theoretically, an optimal design is achieved if the performance curve of a designed system achieves the lowest C-D bound 100. However, it is not realistic to achieve the theoretical bound 100 perfectly with a practical system. For a given system and a given data model (algorithm), each set of test data will give a quality distortion rate. Referring also to FIG. 2, for such a system model, each point of complexity and distortion pair derived from a practical system is called an operational point 202. A group of operational points 202 compose an operational curve, e.g. 204 or 206. For different data models, e.g. algorithms, there will be different operational curves. Each operational point 202 on the operational curve, e.g. 204 or 206, is achievable by the system with a chosen implementation and given test data. Scalability can be defined as a transition between two operating points 202 with different complexity coordinates in the achievable region 106. The best scalable algorithm has an operational curve which closely approximates the lowest C-D bound 100. In FIG. 2, a first given system and data model, i.e. algorithm, gives a first complexity-distortion curve 204, while a second provides curve 206. Theoretically, the distance of operational curves 204, 206 from theoretical lowest complexity-distortion bound 100 illustrates how good each system design is. Often in a real design situation, the lowest bound 100 is not available and the operational curves 204, 206 are not parallel.

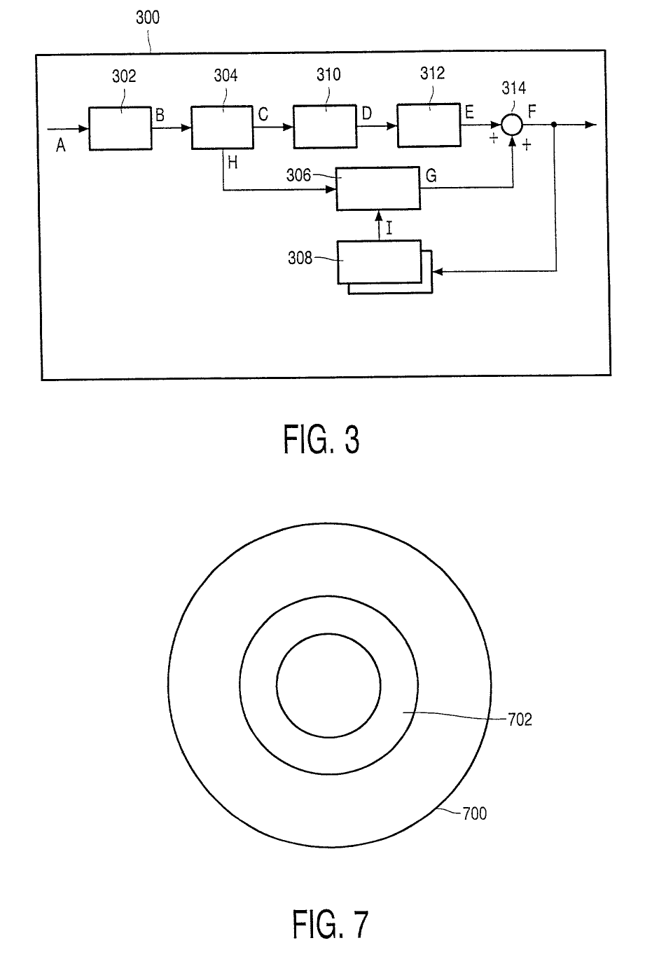

The MPEG2 video decoder used in the above example is commonly employed in Advanced Television Systems Committee (ATSC) compliant Digital Television (DTV) systems. In particular FIG. 3 illustrates a conventional video decoder 300 block diagram suitable for use in an ATSC DTV compliant system as taught by GUIDE TO THE USE OF THE ATSC DIGITAL TELEVISION STANDARD, ATSC Doc. A/54, Oct. 4, 1995.

Briefly, the decoder 300 includes a channel buffer 302 which receives a coded video bitstream signal A and outputs a signal B . A Variable Length Decoder (VLD) 304 receives signal B and reconstructs 8×8 arrays of quantized Discrete Cosine Transform (DCT) coefficients to provide DCT coefficients in quantized form as signal C and motion vectors as signal H. Motion Compensator 306 receives signals H and I, which includes data for anchor frames stored in memory 308 and provides motion compensated predicted pixel values as signal G. Inverse quantizer 310 receives signal C and dequantizes it to provide signal D which includes quantized prediction error DCT coefficients in standard form. Inverse Discrete Cosine Transform (IDCT) 312 receives signal D and transforms it to obtain pixel values or prediction errors as signal E. Adder 314 receives signals E and G and sums them to provide reconstructed pixel values which are degraded by quantization as signal F which is provided as decoded video data and also to memory 308.

It is an object of the current invention to provide a method as set forth above that allocates the resources in an improved way. To achieve this object, the method according to the invention comprises the following steps:

a first step of requesting an algorithm resource by the algorithm to provide a plurality of output quality levels,

a second step of determining that the first function provides a first plurality of quality levels and the second function provides a second plurality of quality levels,

a third step of allocating a budget to the algorithm to enable operating the algorithm at a output quality level, said output quality level being one of the plurality of output quality levels,

a fourth step of assigning a first quality level of the first plurality of quality levels to the first function and of assigning a second quality level of the second plurality of quality levels to the second function. By allocating a budget to an algorithm as a whole, a budget manager, or overall system control does not need to know that the algorithm comprises of a plurality of functions. The overall system control can therefore be used for the general purpose of allocating a budget to algorithms that run on the system simultaneously. The budget is based upon the requested algorithm resources. Instead of allocating a budget to the algorithm, the overall system control can set an output quality level to the algorithm as a whole. The output quality level can be chosen from the plurality of output quality levels the algorithm can provide. Each function of the algorithm can provide a plurality of quality levels. When an algorithm gets allocated a budget or is assigned an output quality, a quality control can assign a corresponding quality level or setting to each function. The corresponding quality level or setting is chosen from the plurality of quality levels that can be provided by a function. The quality level of the function that provides the highest output quality level of the algorithm for the allocated budget can be the preferred choice from the plurality of quality levels that can be provided by a function. The quality control distributes implicitly its allocated budget over the functions the algorithm comprises by the assignment of a corresponding quality level or setting to each function. The assigned quality level per function is based upon the budget that is allocated to the algorithm.

An embodiment of the method according to the invention is described in claim 2. A function can provide a quality level for a plurality of levels of complexity wherein a level of complexity for example is determined by a number of mathematical operations a function can perform, an amount of memory the function requires or communication means, like bandwidth, the function requires. When the algorithm consists of a plurality of functions, each function providing a plurality of quality levels, there are a lot of combinations of level of complexity and quality level possible. A quality control can perform these combinations and can decide upon these combinations which quality level to assign to a function. Furthermore, the knowledge about the complexity of a function while providing the same quality level can lead to more smooth output quality transitions of the algorithm as a whole.

An embodiment of the method according to the invention is described in claim 3. Each function can operate at its own quality level. A combination of the first function and the second function can lead to one algorithm that can provide a plurality of output quality levels. When a new budget is allocated to an algorithm which leads to a different output quality level, the same algorithm can be operated again, by allocating new quality levels to the first and second function as previously described. A number of algorithms providing a same functionality but at a different output quality level that can, for example, be operated in parallel, can be limited this way.

An embodiment of the method according to the invention is described in claim 4. A quality control, for example can choose for each function the lowest complexity for the highest quality level from the plurality of combinations of complexity and quality level per function.

An embodiment of the method according to the invention is described in claim 5. When the allocated budget is substantially equal to the requested algorithm resource, the algorithm does not get allocated substantially more than its requested algorithm resource. This prevents resources being not used by the algorithm, which can cause rejection of other algorithms to operate because their requested resource is already allocated to the algorithm.

An embodiment of the method according to the invention is described in claim 6. When the first amount of resources in addition to the second amount of resources is substantially equal to the allocated budget, the algorithm does not use substantially more than its allocated budget. This prevents budget-overrun by the algorithm which may cause budget shortage of other algorithms or algorithms that can result in missing deadlines of these other algorithms or algorithms and degradation of an overall output quality.

An embodiment of the method according to the invention is described in claim 7. The output quality levels that can be provided by an algorithm can depend upon a hardware platform that the algorithm is operated upon. When, for example, the first function of the algorithm has specific hardware requirements, like for example the availability of a harddisk, the first function may be omitted when the hardware is not available.

An embodiment of the method according to the invention is described in claim 8. The output quality levels that can be provided by an algorithm can depend upon a software platform that the algorithm can access. When, for example, the first function of the algorithm has specific software platform requirements, like for example the availability of a linear interpolation algorithm, the first function may be operated differently when the linear interpolation algorithm is not available, for example by using an available cubic interpolation algorithm.

A further object of the invention is to provide a method for operating a programmable processing device to reduce distortion in an outputted signal, that allocates the resources in an improved way. To achieve this object, this method according to the invention comprises the following steps:

a first step of providing data indicative of a plurality of operational states, each of said states being associated with at least one of a plurality of operational modes of said device, a complexity of operations (C) and a distortion level (D);

a second step of selecting one of said states for each of said complexities using said data and based upon said distortion levels;

a third step of determining an operating status of said device; and,

a fourth step of selecting which of said operational modes to operate said device in for each of said complexities responsively to said determined status using said selected states.

Embodiments of the method for operating a programmable processing device to reduce distortion in an outputted signal according to the invention are described in claims 10 to 15.

A further object of the invention is to provide a scalable programmable processing device that allocates the resources in an improved way. To achieve this object, this device according to the invention comprises:

at least one scalable application operable in plurality of modes each having a different complexity of operations characteristic;

a QOS resource manager for tracking how much computing resources are available for use by said at least one scalable application;

a strategy manager for determining whether said available resources are suitable for operation of said scalable application in a given one of said modes; and,

a local resource control responsive to said strategy manager and for selecting, in response to a determination by said strategy manager that said available resources are not suitable for operation of said at least one application in said given mode to select another of said modes for said at least one application;

wherein, said QOS manager and strategy manager are mutually responsive to one another and said at least one scalable application is responsive to said local resource control.

Embodiments of the scalable programmable processing device according to the invention are described in claims 17 to 19.

Various objects, features and advantages of the invention will become more apparent by reading the following detailed description in conjunction with the drawings, which are shown by way of example only, wherein:

FIG. 1 illustrates a theoretical lowest attainable complexity-distortion bound;

FIG. 2 illustrates two operational modes of a system and the theoretical lowest attainable bound;

FIG. 3 illustrates a conventional video decoder block diagram for an ATSC compliant DTV system;

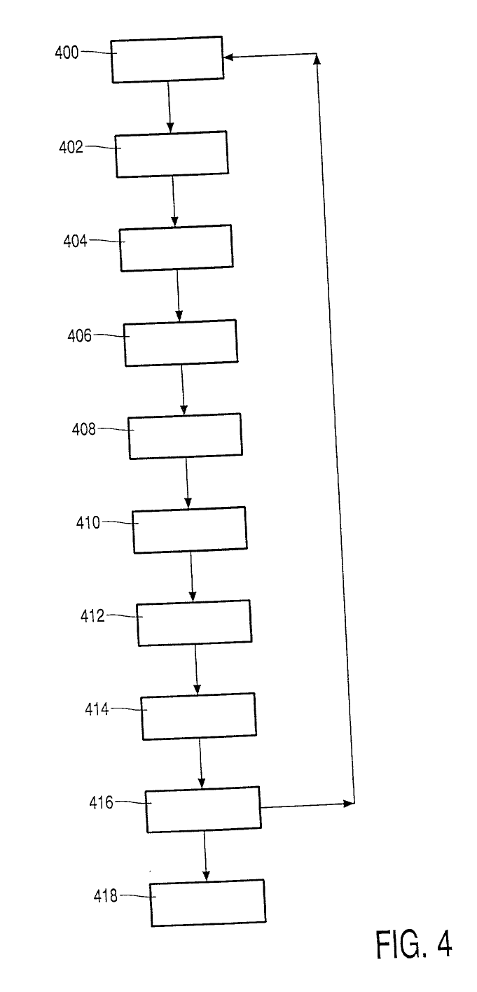

FIG. 4 illustrates an embodiment of the main steps of the method according to the invention,

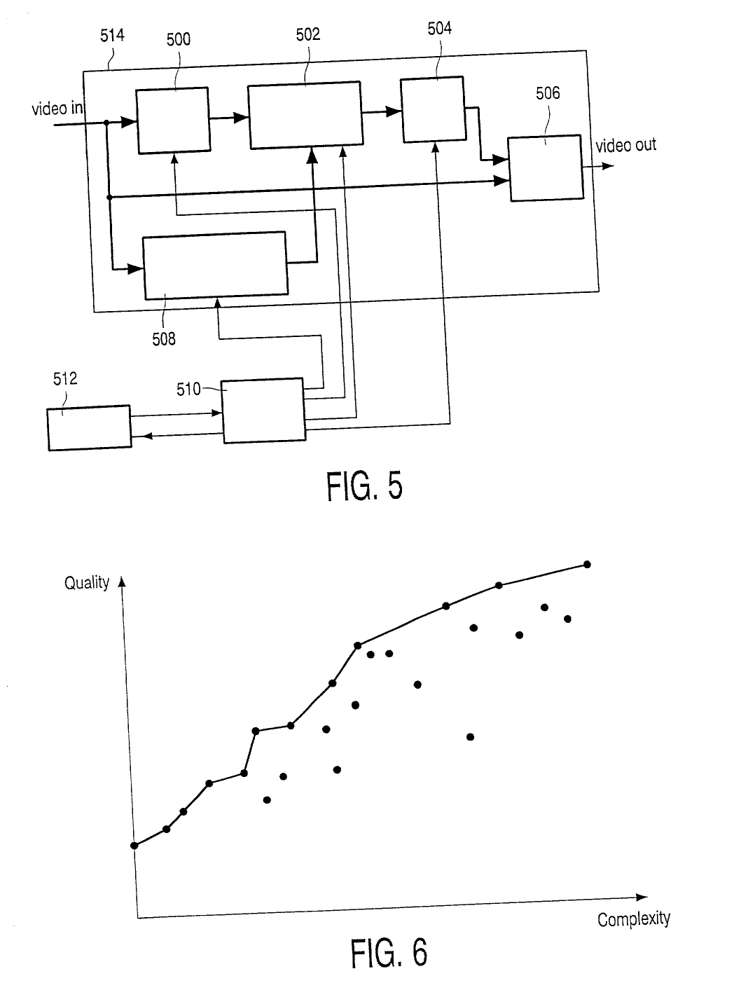

FIG. 5 illustrates an example of an algorithm that comprises a plurality of functions,

FIG. 6 illustrates an example of a diagram in which the complexity of the algorithm is set against the output quality level that can be provided by the algorithm,

FIG. 7 illustrates a storage device in a schematic way that comprises an embodiment of a storage device comprising a computer program product arranged to perform the method according to the invention,

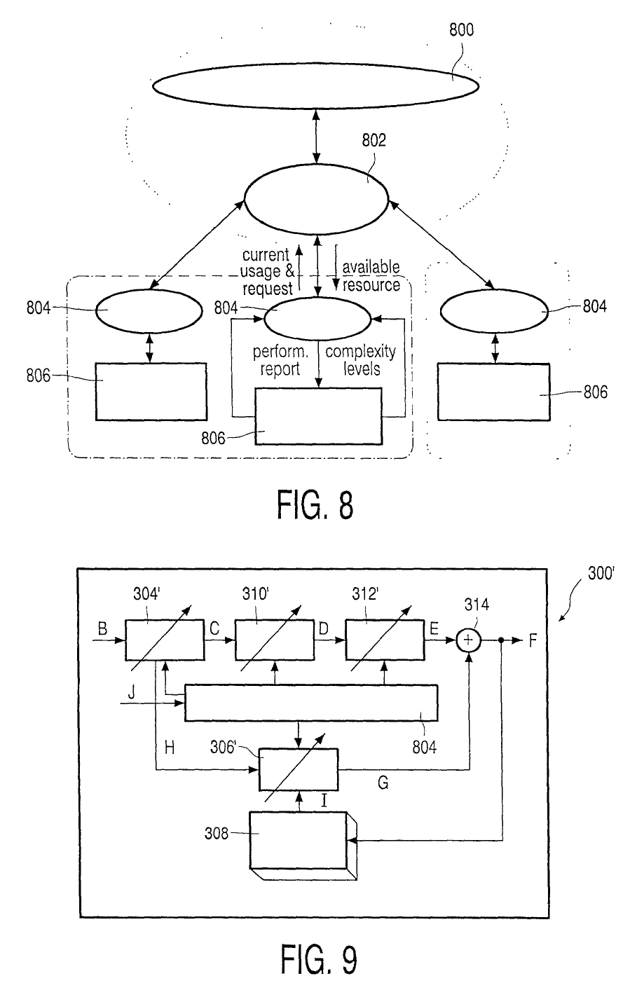

FIG. 8 illustrates a block diagram of a control system used according an embodiment of the present invention;

FIG. 9 illustrates a scalable video decoder block diagram for an ATSC compliant DTV system according to an embodiment of the present invention;

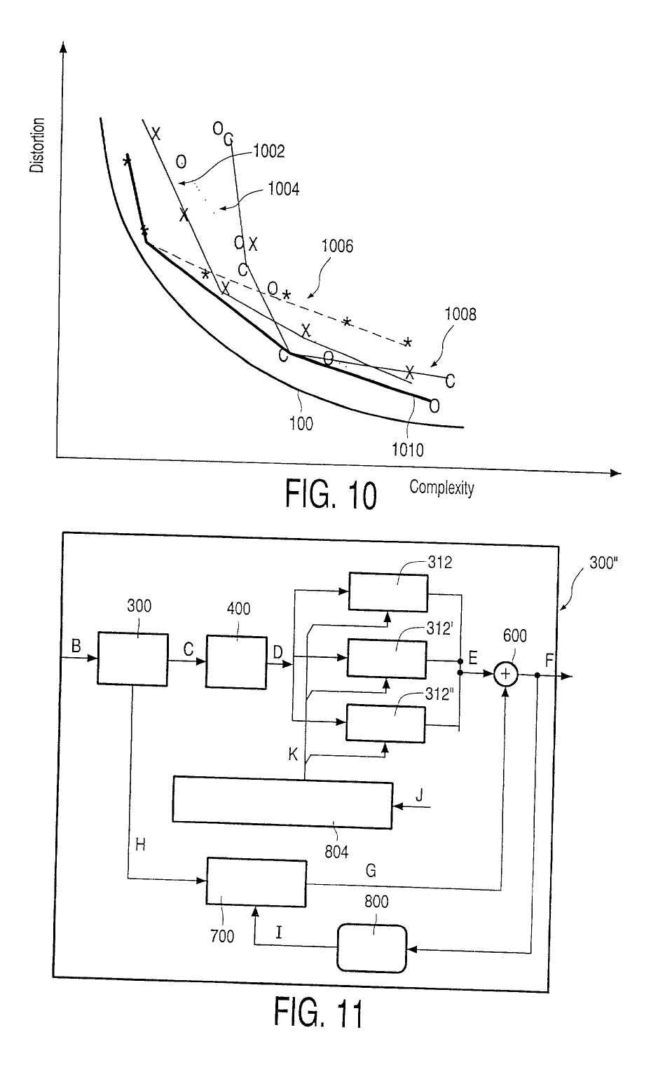

FIG. 10 illustrates a lowest C-D approach among various algorithms according to an embodiment of the present invention; and,

FIG. 11 illustrates a scalable video decoder block diagram for an ATSC compliant DTV system according to another embodiment of the present invention.

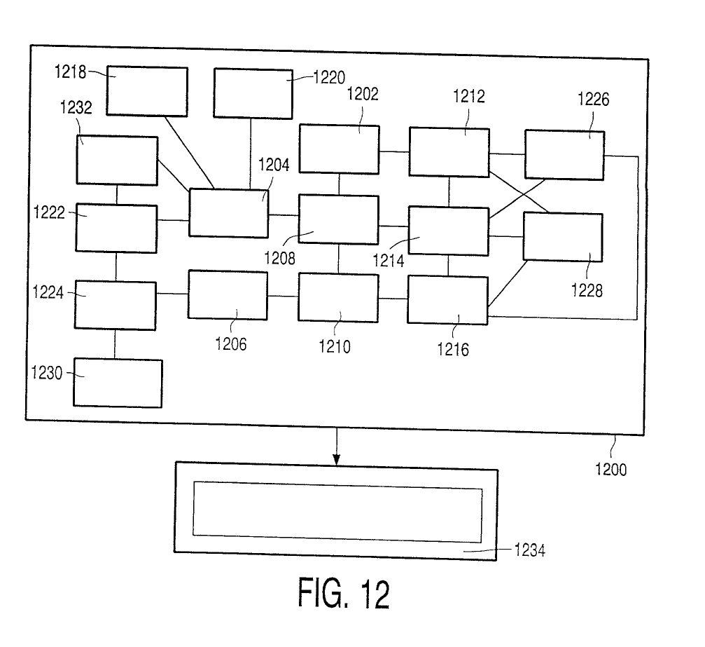

FIG. 12 illustrates the most important parts of an embodiment of the system according to the invention in a schematic way,

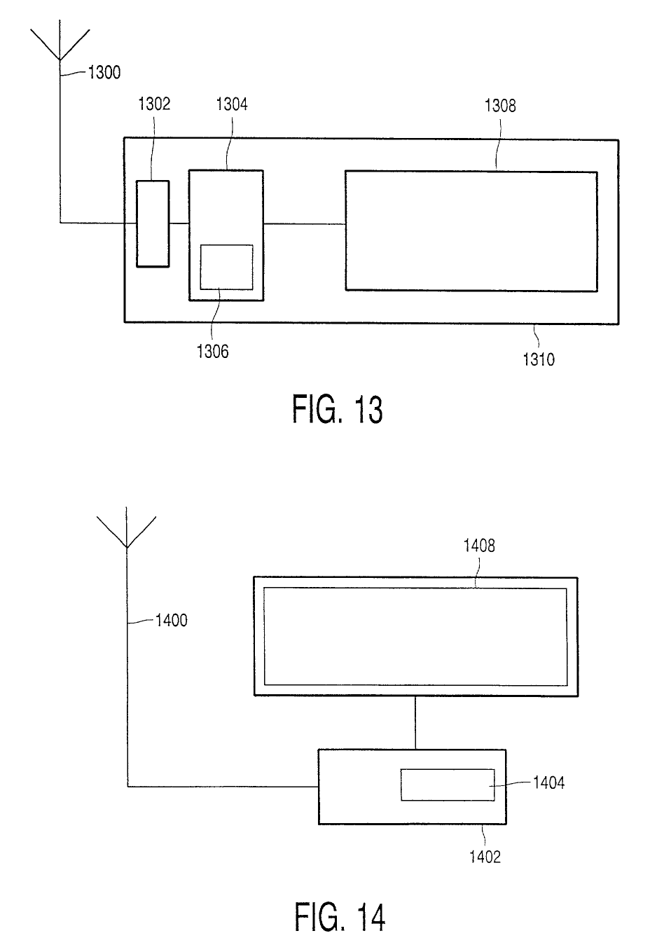

FIG. 13 illustrates a television set in a schematic way that contains an embodiment of the system according to the invention,

FIG. 14 illustrates a set-top box in a schematic way that contains an embodiment of the system according to the invention.

FIG. 4 illustrates an embodiment of the main steps of the method according to the invention. Programmable components, rather than dedicated single-function components can perform continuous media processing. Those single-function components are used in traditional television receivers in which some of those single-function components could be combined to perform for example color decoding for NTSC or PAL systems, noise reduction or frame rate up-conversion. With the introduction of programmable components, continuous media processing algorithms can be implemented in software instead of hardware. Some of the expected advantages of the software implementation of media processing algorithms are: reduced time to market, re-use of hardware, re-use of software algorithms, portability, and flexibility. The software implementation of the media processing algorithms must run within the real-time environment in which system resources are finite and sufficient system resources may not be reserved for a particular processing algorithm, which can lead to changes in the output quality provided by the particular processing algorithm. Output quality levels can be measured by perception measurements, or objectively by available measurement means. A system running the processing algorithms is able to provide high-quality audio and video that has a relatively high frame rate above 50 Hz, almost no tolerance for frame rate fluctuations and a low tolerance for frame skips. Preferably, the system is also able to provide low frame rates with a maximum of 30 Hz, a high tolerance for frame rate fluctuations and a high tolerance for frame skips.

Algorithms can be allocated budget explicitly or implicitly by setting an output quality level of the algorithm. One of the objectives of an overall system control is to optimize the total output quality provided by the total system while making efficient use of all the available resources. The total output quality provided by the system depends amongst others upon the number of algorithms operating concurrently and the data an algorithm processes. The system may be, for example, a television, a PC, a display, a set-top box, or a VCR. In order to achieve this objective, the main steps below are performed.

Here, step 400 is an initialization step in which an overall system control, for example a budget manager accesses the contents of a first lookup table as illustrated in Table 1. In this table, “CPU”, “co-processor” and “memory requirements” are examples of resources that an algorithm can use. Furthermore, a higher number that is denoted in the column named “quality number” indicates a better output quality level perceived by a user. By accessing the contents of this first lookup table, the overall system control determines the predefined amount of resources, for example CPU cycles, an algorithm requests to provide a predefined output quality level.

TABLE 1

| | CPU | co-processor | memory requirements |
|---|---|---|---|
| Quality number | [cycles] | [cycles] | [bytes] |
| 79 | 39 | 22 | 3 |
| 68 | 28 | 12 | 3 |

The algorithm, or a quality control, which is part of the algorithm, can have access to the contents of Table 1 too. Algorithms are started implicitly when a user switches to another channel for a main window and the, analog, source of the new channel is different from the, digital, source of the old channel. Other examples of starting algorithms or changing the resource requirement of an algorithm are:

when a user exchanges the contents of a main window and a picture in picture window by for example viewing the re-play after a goal,

when the size of a video conferencing window changes, or

when a new application, for example a video conferencing application when a call arrives, is started in an additional window. The resource requirement of an algorithm changes too when the media data the algorithm processes changes. A change in the media data can be caused by the service provider that may transmit sources with different input parameters, for example when a movie which can be a 24 Hz film is interrupted by a commercial which can be a 60 Hz camera or it can be caused by motion or scene changes.

Within step 402 the functions a media processing algorithm comprises is determined by, for example, reading this information from some configuration file. This file describes that, for example, an algorithm for edge or sharpness enhancement comprises the functions as is illustrated in a schematic way in FIG. 5. Within this Figure, a detail filter 512, a non-linear function 502, a gain 504, an adder 506, and noise measurement 508, is shown. The detail filter extracts higher frequency components from an input signal containing a video signal. Those components can be added to the input signal to increase the overall sharpness impression of the video signal. The non-linear function and following gain can reduce artifacts like clipping caused by the detail filter whereas the noise measurement function can adapt the sharpness enhancement dependent upon the noise level contained within the input signal.

Within step 404 the requested resources and the quality level per function are determined. In order to separate concerns, a quality control 510, see FIG. 5, shields the overall system control from the functions an algorithm comprises and is part of the algorithm. Within the algorithm for edge or sharpness enhancement, the detail filter varies its requested resources for, for example, number of CPU cycles or number of bytes. The variation of requested resources is determined by the quality levels described by the coefficients for the filter and the type of filter: horizontal, vertical, or both. The non-linear function varies its requested resources for, for example, CPU cycles and is determined by the quality levels described by the quantization of the non-linear function, which can differ for the input signal and output signal. The gain varies its requested resources for, for example, a multiplier, shift and adder operations dependent upon whether it is stored as fixed values in a lookup table contained in memory, it is calculated by a multiplier or is calculated by shift and adder operations. The noise measurement varies its requested resources for, for example CPU cycles, because it can, for example, be switched on or off. The adder operation can vary its requested amount of resources by for example doing less precise additions. However, adder operations that cannot vary their requested amount of resources but provide a predefined quality level for a predefined amount of resources, for example CPU cycles, can be used too. The combination of all settings for requested resources and quality level per function, results in a large design space in which the complexity of the algorithm, or of a function of the algorithm, or of a combination of functions of the algorithm is set against its quality level. The result is summarized into, for example, a second lookup table as illustrated in Table 2. In this table, there are three main columns: “version”, which assigns a unique number to a row, “quality”, which groups all parameters concerning the output quality level a algorithm can provide, and “complexity”, which groups all parameters concerning the complexity of the algorithm. The mentioned parameters are not limiting, for example, store operations or communication means like bandwidth and cache can be used as parameters concerning the complexity of the algorithm. Furthermore, the numbers used for the quality and complexity within Table 2 are absolute, but may be normalized to operations per pixel within video independently from the chosen format. With this concept, a media algorithm designer designs the functions the media algorithm comprises to provide the correct functionality at different output quality levels.

TABLE 2

| | | | | | | | Complexity | | | | | | |
|---|---|---|---|---|---|---|---|---|---|---|---|---|---|
| | Quality | | | | | | adder | | | | shift | Memory | |
| | quality | PSNR | Horizontal | Vertical | Temporal | | operations | | multiplications | | operations | requirement | |
| Version | number | [dB] | processing | processing | processing | . . . | CPU | co-processor | CPU | co-processor | CPU | [bytes] | . . . |
| 1 | 79 | 45 | 1 (yes) | 1 (yes) | 1 (yes) | . . . | 14 | 10 | 20 | 12 | 5 | 3 | . . . |
| 2 | 79 | 45 | 1 (yes) | 1 (yes) | 1 (yes) | . . . | 24 | 0 | 32 | 0 | 28 | 5 | . . . |
| 3 | 68 | 39 | 1 (yes) | 1 (yes) | 0 (no) | . . . | 10 | 8 | 12 | 4 | 6 | 3 | . . . |
| 4 | 67 | 39 | 1 (yes) | 0 (no) | 1 (yes) | . . . | 9 | 4 | 10 | 4 | 6 | 2 | . . . |
| 5 | 61 | 37 | 0 (no) | 1 (yes) | 1 (yes) | . . . | 10 | 0 | 11 | 0 | 7 | 3 | . . . |
| 6 | 54 | 35 | 1 (yes) | 0 (no) | 0 (no) | . . . | 8 | 3 | 9 | 3 | 6 | 1 | . . . |
| . . . | . . . | . . . | . . . | . . . | . . . | . . . | . . . | . . . | . . . | . . . | . . . | . . . | . . . |
| N | 12 | 25 | 1 (yes) | 0 (no) | 0 (no) | . . . | 4 | 0 | 3 | 0 | 12 | 0 | . . . |

Within step 406 the contents of the table is updated for the available software platform the algorithm has access to. For example, when the software platform does not support “temporal processing”, this column is removed from the table and the effectuated rows are updated correspondingly. When for example “horizontal processing” is not supported, the corresponding column and the rows which do not lead to any processing at all, like row 6 and N, are removed from the table. It is also possible to instantiate a run-time lookup table containing a mapping from software functions available within the software platform to software functions required by the algorithm instead of updating Table 2.

Within step 408 the contents of the table is updated for the available hardware platform the algorithm must be operated upon. For example, when the hardware platform does not provide a co-processor, this column is removed from the table and all rows are removed that only used a co-processor. It is also possible to instantiate a run-time lookup table containing a mapping from hardware available within the hardware platform to hardware required by the algorithm instead of updating Table 2.

After these steps, the functions an algorithm comprises, the plurality of quality levels the different functions provide, the plurality of output quality levels the algorithm provides and the hardware and software the algorithm requires from the hardware platform and software are known to the quality control. The overall system control only needs to know about the algorithm, the resources the algorithm requests, the hardware it requires and the plurality of output quality levels the algorithm provides.

Within step 410 the overall system control allocates a resource budget to the algorithm in accordance with a best overall system's output quality level. A best overall system's output quality level can be achieved when the system is in a steady state in which all algorithms that are running provide a predefined output quality level and the system is fully loaded. This means that additional algorithms can not be started without adjusting the output quality levels of the running algorithms. The budget that is allocated is substantially equal to the resources requested by the algorithm to provide a predefined output quality level. When the algorithm gets allocated less budget than requested, the algorithm may not provide the predefined output quality level and when the algorithm gets allocated more budget than requested, the algorithm may not use all resources. The overall system control 512, see FIG. 5, allocates the budget to the algorithm based upon the contents of Table 1. The overall system control 512 can allocate the budget to the algorithm based upon the contents of Table 2. In the latter case, the overall system control decides upon a more smooth transition of the output quality level provided by the algorithm. As is shown in Table 2, an abrupt transition of the output quality level provided by the algorithm is likely from version 2 to version 6, or from version 5 to version 6, because the processing changes in two dimensions. A more smooth transition is expected from version 2 to version 3, because the processing changes only in one dimension. The other “quality” parameters like the quality number or PSNR also provide information about the smoothness of transitions. The information about the hardware platform and software platform as derived in steps 406 and 408, can also be accessed by the overall system control. Selection of the output quality level provided by the algorithm is then based upon for example the available hardware. This is shown in Table 2, where version 1 and version 2 provide the same output quality level because their quality numbers are equal, but they distribute the required resources differently between the CPU and co-processors. The quality control can use this knowledge of distribution between CPU and co-processors to deal, amongst others at run-time, with overload situations in which the quality control can change the distribution, while the algorithm still provides the same output quality.

Within step 412 the quality control translates the allocated budget, or output quality level, to the algorithm as a whole into a quality level allocation to the different functions the algorithm comprises. This translation is based upon the contents of Table 2 and takes the combination of all settings for requested resources and quality level per function into account. The combination of all settings for requested resources determines the complexity of the algorithm, a function of the algorithm and a combination of the functions of the algorithm. The complexity is expressed with a number. This number is weighted to get a single number for a specific hardware or software platform. FIG. 6 shows an example of the combination of the complexity and provided output quality level. Useful combinations are achieved at the highest output quality for the lowest complexity as is indicated by the drawn curve in FIG. 6. Each dot implies different quality settings or quality levels for the functions an algorithm comprises. The information about the hardware platform and software platform as derived in steps 406 and 408 is accessed by the quality control. The quality control uses this information to choose the best combination of the complexity and provided output quality level, because the best combination and the number of combinations can depend upon the hardware and/or software platform the functions must run upon. Changing the resolution of video data by for example sub-sampling the video data or deleting entire frames, lines or pixels is prevented by interpretation of the contents of Table 1 and Table 2 as previously described. The quality control also maximizes the perceptual quality because a user perceives a low output quality provided by the system, when the quality of, for example a movie, is changed continuously. Therefore quality levels are sparingly adjusted.

Within step 414, the quality control re-allocates the translated allocated budget to the functions the algorithm comprises implicitly, by assigning the corresponding quality level to the functions.

Within step 416 the functions and therefore the algorithm as a whole start operating using their allocated budget and set quality level. After completion of the algorithm, step 400 can be performed again or the final step 418 is reached.

FIG. 7 illustrates, in a schematic way, a storage device that comprises a computer program product arranged to perform the method according to the invention. Here, 700 is a compact-disk comprising code 702.

Furthermore, the present invention involves comparing different C-D curves that achieve the same task, so that an algorithm which is more efficient regarding the trade-off of the complexity and the quality distortion at certain complexity levels than available alternatives can be identified. Therefore the best algorithm which gives the minimal quality distortion at certain complexity can be selected, and the global optimal approach can be achieved for the given set of algorithms under assumed complexity and distortion ranges.

Referring now to FIG. 8, the scalable video algorithm design control system made according to the concepts of the present invention preferably includes four elements: a Quality Of Service (QOS) resource manager 800; a strategy manager 802; a local resource control 804; and scalable algorithms 806. The QOS resource manager 800 oversees resource usage within an entire system, or grouped subsystems. It sends out control commands to the strategy manager 802 when system resources vary, and receives feedback from the strategy manager 802 when subsystems are scaled. The strategy manager 802 serves as an envoy for the QOS manager 800 which has the power to command different scalable algorithms' 806 via local controller 804 to scale up or down in order to adapt to the resource level change. Although the strategy manager 802 controls the overall scaling of levels of different applications, it does not control the detail of the scalability of a specific algorithm 806. For example, it controls the total complexity level of the MPEG2 decoder, but it does not have the control about which algorithm of the MPEG2 decoder should be scaled down to what level. This is the work of the local resource control 804. The local resource control 804 (also known as decoding resource control or complexity switching control) knows exactly how each functional block inside of the MPEG2 decoder is scaled and to what level. Ultimately, the scalable algorithms 806 are the keys that fulfill the scalability job.

In other words, it should be understood that in general QOS is well understood by those possessing an ordinary skill in computer quality control/information management. The QOS manager 800 basically manages the use of computing resources, e.g. in use, not in use, monitors information flow, and responds to requests from applications that demand or are using resources. The strategy manager 802 satisfies a need for communication between the QOS manager 800 and scalable applications which use the scalable algorithms 806, such as the scalable MPEG2 decoder of FIG. 9 or 11. The strategy manager 802 handles and controls the resource uses of each individual scalable application and coordinates these applications.

The local resource control 804 serves as a local office manager for a particular scalable application. For example, and referring now to FIG. 9, therein is illustrated a scalable ATSC compliant DTV video decoder according to the present invention. Therein, the elements designated with a′ designate like elements to those of FIG. 3, except that they are scalable in accordance with the present invention. Hence, more than one functional block within the decoder 300′ of FIG. 9 is scalable. In the MPEG2 decoder 300′ the IDCT is one functional block for example. The local resource manager 804 (also referred to as Decoding Resource Control) coordinates the activities and scalable levels of these blocks, e.g. how much each individual functional block should be scaled. If multiple scalable algorithms 806 are available for a particular functional block, e.g. an IDCT, in order to achieve minimal distortion, when and where the switching of multiple algorithms, e.g. 204, 206, should apply, these control tasks are performed by the local resource manager 804.

As discussed above, the fundamental research proves that the lowest complexity-distortion (C-D) bound 100 in a C-D plane exists. However, to design a system which is ideally on this bound 100 is not practical. In order to best achieve/approach this theoretical lowest bound 100, system designers usually search for the single best algorithm that can approach the bound 100 for different complexity levels. Usually a single algorithm is selected from a group of algorithms for the best match. But as is clearly illustrated in FIG. 2 for example, the operational 204, 206 curves of different algorithms may cross each other. This implies that one algorithm has a lower complexity level than the other at one distortion rate, but does not necessarily result in a lower complexity level at a different distortion rate.

Referring now to FIG. 10, in order to better approach the global optimal C-D bound 100, and according to a preferred form of the present invention: the operational curves of available algorithms are measured; then for a possible given data set, the algorithm which yields the lowest distortion rate for each complexity level within the operational curves is selected; finally, switch points on different operational curves are selected which results in a new global optimal operational curve. In other words, according to the present invention, switches between different algorithms 1002, 1004, 1006, 1008 are advantageously utilized to provide a better operational curve 1010 than any of the individually tested algorithms 1002, 1004, 1006, 1008.

Referring now also to FIG. 11, therein is illustrated another ATSC compliant DTV video decoder 300″ according to the present invention which includes a scalable IDCT functional block 312, 312′, 312″. Using the IDCT functional block 312, 312′, 312″ of MPEG2 decoder 300″ as an embodiment of the disclosure, this approach proposes to use multiple Discrete Cosine Transform (DCT) algorithms to achieve an optimal scalability of the decoder with regards to the computation complexity and the quality. For a given complexity level, a DCT algorithm that is chosen to give the minimal distortion level.

It should be recognized that theoretically, if an infinite number of algorithms are available the lowest C-D bound 100 could be approached or nearly achieved by performing all the comparisons therebetween and selecting the best fit at each complexity. Practically however, the number of available algorithms and the comparison time are limited by design criteria, and the number of operational switching points is also limited as will be discussed. Therefore the approach of the present invention is to get the lowest possible quality distortion under certain given complexity using a certain number of available algorithms.

Referring still to FIG. 11, therein is illustrated a video decoder 300″ block diagram for an ATSC compliant DTV system according to another form of the present invention. As can be readily ascertained, the decoder 300″ incorporates many of the same elements as the decoder 300 of FIG. 1, therefore a discussion of these like elements will not be repeated. Referring now also to FIGS. 3 and 9, in contrast to the decoder 300 though, the decoder 300″ includes multiple IDCT's 312, 312, 312 and complexity switch 804 while the decoder 300′ includes an IDCT 312′ which can implement multiple algorithms and switch 804. The complexity switch 804 is responsive to signal J which originates from strategy manager 802. The switch control 804 outputs signal K in response to signal J which selectively activates ones of IDCT's 312,312, 312. In the illustrated case of FIG. 11, there are n IDCTs, 312, 312′, 312″ which are switched between to provide n different algorithms. Alternatively, one or more IDCT's which are selectably activatable to use different algorithms can be used such as is illustrated in FIG. 9.

Referring again to FIG. 8 also, the QOS 800 determines how much, or what percentage of Central Processing Unit (CPU) cycles, i.e. processing power, the MPEG2 decoder 300″ is entitled to use. This may or may not be enough for full power MPEG2 decoding, i.e. non-scalable. The strategy manager 802 receives this budget, together with other budgets for other applications. The strategy manager 802 determines if this budgeted amount of computing or processing power is sufficient for full decoding. If the budgeted amount of computing power is not sufficient for a non-scalable decoding, it will either inform the local resource control 804 to activate a scalable algorithm 806, or request more resources from QOS manager 800 for robustly maintaining a suitable output quality. Assuming the local resource manager 804 of the MPEG2 decoder 300″ receives the reduced budget, based on statistics gathered in advance, by using one or more look-up tables for example, a determination is made as to which scalable algorithm 204 will be activated at what level of available processing power. Assuming the global optimal IDCT algorithm according to the present invention is activated, and since the complexity versus distortion relationship is determined off-line in advance, at each complexity level the local resource manager 804 has a well defined algorithm to call and use, as corresponding to a particular operational point.

For different algorithms, the complexity stretch is different. Not all the available algorithms will provide the same range of complexity-distortion measurement and range. The operational points for different algorithms may offset each other. The metric for complexity measurement for different algorithms should be universal, or scaled to the comparable level. The total number of machine cycles running the algorithm can be defined as the complexity level of the algorithm. However, in high level simulation of the scalable algorithms, it may not be realistic to measure the machine cycles as machine cycles are platform and CPU dependent. In such a case, the multiplication reduction ratio can be used as a complexity measurement.

According to one embodiment of the present invention, a procedure to obtain an operational C-D curve is as follows: Step 1. The operational points of available algorithms are measured under different complexity levels; Step 2. Scale the operational points of different algorithms to the same scale and draw the operational curves on the same plot; Step 3. Find the switching points (cross points) of the operational curves; and, Step 4. The global optimal operational curve 1010 is decided by selecting each operation curve portion which is nearest to the C-D curve 100 between each of the switching points.

To summarize, the disclosed method proposes a way to better approach the global optimal complexity-distortion bound 100 for a given system using multiple schemes, e.g. algorithms or modes. This method is based on the information-based complexity theory and is practically achievable. It can be used in scalable multimedia/communication system design and scalability analysis.

The order in the described embodiments of the methods of the current invention is not mandatory, a person skilled in the art may change the order of steps or perform steps concurrently using threading models, multi-processor systems or multiple processes without departing from the concept as intended by the current invention. Furthermore, the introduced quality control and overall system control express roles or concepts that can be used within the methods of the current invention.

FIG. 12 illustrates the most important parts of an embodiment of the system according to the invention in a schematic way. The system, 1200, comprises a first memory 1202 that contains per resource an amount of that resource an algorithm requests to provide a predefined output quality level. A CPU and a co-processor are examples of resources of which cycles can be requested. A second memory 1204, contains a module to perform a first function of the algorithm, while a third memory 1206, contains a module to perform a second function of the algorithm. Consider the edge or sharpness enhancement algorithm 514, as described in FIG. 5. The second memory 1204 contains the module that performs detail filtering 500, while the third memory 1206 contains the module that performs noise measurement 508. The system may also contain more memories containing modules that perform all the functions of the edge or sharpness enhancement algorithm as described in FIG. 5. The fourth memory, 1208 contains a lookup table containing per quality level of a first plurality of quality levels the first function can provide, the amount of resources it requires. The fifth memory, 1210 contains a lookup table containing per quality level of a second plurality of quality levels the second function can provide, the amount of resources the second function requires. After the overall system control allocates a budget per resource, as previously described, the sixth memory 1212 contains per resource the amount of budget allocated to the algorithm. The overall system control can also assign the output quality level of the algorithm as a whole, thereby implicitly allocating a budget per resource to the algorithm. Furthermore, the memories 1214 and 1216 contain the quality levels provided by the first and second function of the algorithm respectively. Memory 1218 contains a plurality of complexity numbers indicating a plurality of levels of complexity of operation of the first function of the algorithm. Memory 1220 contains a complexity number indicating the least complex level of operation of the first function of the algorithm. In order to determine the content of memories 1214 and 1216 as previously described the quality control has access to the contents of memory 1218 and 1220. The contents of memories 1202, 1208, and 1210, 1218, 1220 can also be combined into one lookup table as illustrated in Table 2. This combined lookup table can then be stored into one memory instead of more separate memories. Furthermore, when the system is realised in silicon in which the functions and lookup table are hard-wired to each other, the memories 1212, 1214 and 1216 may be omitted. The quality control accesses the contents of memory 1226 that contains a configuration file containing information about the available hardware within the system and it accesses the contents of memory 1228 that contains a configuration file containing information about the available software algorithms within the system. The quality control has access to all previously described memories, whereas the overall system control only requires access to memories 1202, 1212, 1226 and 1228. However, when the overall system control has access to more memories, the output quality level transitions provided by the algorithm can become smoother. The system also comprises a first co-processor, 1222, on which the first function of the algorithm can run and a second co-processor, 1224, which on which the second function of the algorithm can run. An, optional, CPU, 1230, operates the algorithm as a whole, because there needs to be some inter-process communication between the first and second function. When the system does not contain co-processors, the functions and therefore, the algorithm run on the CPU. When the first function can be operated at a plurality of levels of complexity, the first function runs at the least complex level on a dedicated co-processor 1232, while the more complex level is run on the co-processor 1222. It is also possible that the first function runs at each of the plurality of levels of complexity on either 1232 or 1222 or that the first function runs at each of the plurality of levels of complexity on CPU 1230. This system can be realised in software intended to be operated as an application by a computer or any other standard architecture able to operate software. The system can be used to operate a digital television set 1234. The system can also be realised in silicon wherein the mentioned lookup tables are replaced by logical building blocks that are hard-wired to each other and the mentioned processors and co-processors are omitted.

FIG. 13 illustrates, in a schematic way, the most important parts of a television set that comprises an embodiment of the system according to the invention. Here an antenna, 1300 receives a television signal. The antenna may also be for example a satellite dish, cable, storage device, internet, Ethernet or any other device able to receive a television signal. A receiver, 1302 receives the signal. The signal may be for example digital, analog, RGB or YUV. Besides the receiver 1302, the television set contains a programmable component, 1304, for example a programmable integrated circuit. This programmable component contains a system according to the invention 1306. A television screen 1308 shows images that are received by the receiver 1302 and are processed by the programmable component 1304, the system according to the invention 1306 and other parts that are normally contained in a television set, but are not shown here.

FIG. 14 illustrates, in a schematic way, the most important parts of a set-top box that comprises an embodiment of the system according to the invention. Here, an antenna 1400 receives a television signal. The antenna may also be for example a satellite dish, cable, storage device, internet, Ethernet or any other device able to receive a television signal. A set-top box 1402, receives the signal. The signal may be for example digital, analogue, RGD or YUV. Besides the usual parts that are contained in a set-top box, but are not shown here, the set-top box contains a system according to the invention 1404. The television set 1406 can show the output signal generated from a received signal by the set-top box 1402 together with the system according to the invention 1404. The output signal may also be directed to a storage device like a VCR, DVD-RW or a harddisk or they may be directed to an internet link instead of being directed to the television set.

1. A method of running an algorithm wherein the algorithm comprises a first function and a second function, the method comprising the following steps:
a first step of requesting an algorithm resource by the algorithm to provide a plurality of output quality levels,
a second step of determining that the first function provides a first plurality of quality levels and the second function provides a second plurality of quality levels,
a third step of allocating a budget to the algorithm to enable operating the algorithm at a output quality level, said output quality level being one of the plurality of output quality levels,
a fourth step of assigning a first quality level of the first plurality of quality levels to the first function and of assigning a second quality level of the second plurality of quality levels to the second function.

2. A method of running an algorithm according to claim 1, further comprising a fifth step of determining that the first function, while providing the first quality level, can be operated at a plurality of levels of complexity.

3. A method of running an algorithm according to claim 1, further comprising the following steps:
a sixth step of operating the algorithm at the output quality level.
a seventh step of operating the first function at the first quality level while consuming a first amount of resources by the first function and operating the second function at the second quality level while consuming a second amount of resources by the second function.

4. A method of running an algorithm according to claim 3, further comprising an eighth step of operating the first function at a least complex level of the plurality of levels of complexity.

5. A method of running an algorithm according to claim 1, wherein the allocated budget is substantially equal to the requested algorithm resource.

6. A method of running an algorithm according to claim 3, wherein the first amount of resources in addition to the second amount of resources is substantially equal to the allocated budget.

7. A method of running an algorithm according to claim 1, further comprising a ninth step of determining a hardware platform operating said method to determine the algorithm resource and the plurality of output quality levels.

8. A method of running an algorithm according to claim 1, further comprising an tenth step of determining a software platform operating said method to determine the algorithm resource and the plurality of output quality levels.

9. A method for operating a programmable processing device to reduce distortion in an outputted signal, the method comprising the following steps:
a first step of providing data indicative of a plurality of operational states (202), each of said states (202) being associated with at least one of a plurality of operational modes (1002, 1004, 1006, 1008) of said device, a complexity of operations (C) and a distortion level (D);
a second step of selecting one of said states for each of said complexities using said data and based upon said distortion levels;
a third step of determining an operating status of said device; and,
a fourth step of selecting which of said operational modes to operate said device in for each of said complexities responsively to said determined status using said selected states.

10. A method for operating a programmable processing device to reduce distortion in an outputted signal according to claim 9, wherein said selected operational mode for a first determined status is different from said selected operational mode for a second determined status.

11. A method for operating a programmable processing device to reduce distortion in an outputted signal according to claim 9, wherein said second step is based upon minimizing said distortion level for said complexity.

12. A method for operating a programmable processing device to reduce distortion in an outputted signal according to claim 9, wherein said first step comprises using at least one lookup table.

13. A method for operating a programmable processing device to reduce distortion in an outputted signal according to claim 9, wherein said programmable device is a multimedia communications device.

14. A method for operating a programmable processing device to reduce distortion in an outputted signal according to claim 9, wherein said device is an ATSC compliant digital television decoder including at least one IDCT, and each of said modes corresponds to a different mode of operation of said at least one IDCT.

15. A method for operating a programmable processing device to reduce distortion in an outputted signal according to claim 9, wherein said selecting comprises determining which of said modes provides a complexity-distortion characteristic desirable to those of said other modes for performing said task using said available amount of computing resources.

16. A scalable programmable processing device comprising:
at least one scalable application (300′) operable in plurality of modes each having a different complexity of operations characteristic;
a QOS resource manager (800) for tracking how much computing resources are available for use by said at least one scalable application (300′);
a strategy manager (802) for determining whether said available resources are suitable for operation of said scalable application (300′) in a given one of said modes; and,
a local resource control (804) responsive to said strategy manager (802) and for selecting, in response to a determination by said strategy manager (802) that said available resources are not suitable for operation of said at least one application (300′) in said given mode to select another of said modes for said at least one application (300′);
wherein, said QOS manager (800) and strategy manager (802) are mutually responsive to one another and said at least one scalable application (300′) is responsive to said local resource control (804).

17. A scalable programmable processing device according to claim 16, further comprising a memory accessible to said local resource control.

18. A scalable programmable processing device according to claim 17, wherein said memory includes a data being indicative of complexity-distortion characteristics of each of said modes for a plurality of amounts of available system resources.

19. A scalable programmable processing device according to claim 16, wherein said device is an ATSC compliant digital television decoder including at least one IDCT, and each of said modes corresponds to a different mode of operation of said at least one IDCT.

20. A scalable MPEG2 compatible video decoder comprising:
at least one variable length decoder (304′);
at least one inverse quantizer (310′) coupled to said variable length decoder (300′);
at least one inverse discrete cosine transform (312′) coupled to said inverse quantizer (310′);
at least one motion compensator (306) coupled to said variable length decoder (304′);
a summing junction (314) coupled to said inverse discrete cosine transform (312′) and motion compensator (306); and,
a controller (804);
wherein at least one of said variable length decoder (304′), inverse quantizer (310′), inverse discrete cosine transform (312′) and motion compensator (306) is coupled to said controller and responsive thereto to operate in one of a plurality of modes each having a given complexity characteristic for an acceptable distortion level of an output of said decoder; and,
wherein said controller selects said one of said modes based upon said given complexity characteristics.

21. A scalable MPEG2 compatible video decoder according to claim 20, wherein said controller selects said one of said modes further based upon an available amount of computing resources for operating at least one of said variable length decoder (304′), inverse quantizer (310′), inverse discrete cosine transform (312′) and motion compensator (306′).

22. A scalable MPEG2 compatible video decoder according to claim 20, wherein said at least one inverse discrete cosine transform (312′) includes a plurality of inverse discrete cosine transforms (312, 312′, 312″) which is selectively operable in response to said controller (804).

23. A scalable MPEG2 compatible video decoder according to claim 22, wherein said selectively operated inverse discrete cosine transform (312, 312′, 312″) implements said selected one of said modes.

24. A scalable MPEG2 compatible video decoder according to claim 23, wherein said complexity-distortion characteristic of said selected one of said modes is more efficient than those of the others of said plurality of modes.

25. A computer program product arranged to perform the method according to any of the claims 1 to 15.

26. A storage device (700) comprising a computer program product according to claim 25.
